(19) United States
(12) Patent Application Publication
(10) Pub. No.: US 2009/0241099 A1
(43) Pub. Date: Sep. 24, 2009

(54) IMAGE FORMING APPARATUS AND FIRMWARE HISTORY INFORMATION OFFERING METHOD THEREOF

(75) Inventors: Dae-yel Lee, Suwon-si (KR); Kee-chang Lee, Hwaseong-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/370,061

(22) Filed: Feb. 12, 2009

(30) Foreign Application Priority Data
Mar. 18, 2008 (KR) 2008-25084

(51) Int. Cl. G06F 9/44

(52) U.S. Cl. 717/168

(57) ABSTRACT

A method of offering upgrade history information about firmware of an image forming apparatus, including receiving and storing a firmware upgrade history document and a firmware upgrade file; upgrading the firmware by executing the stored firmware upgrade file; and offering the stored firmware upgrade history document.

### CROSS-REFERENCE TO RELATED APPLICATION

This application claims priority from Korean Patent Application No. 2008-25084, filed in the Korean Intellectual Property Office on Mar. 18, 2008, the disclosure of which is incorporated herein by reference.

### BACKGROUND OF THE INVENTION

1. Field of the Invention

Aspects of the present invention relate to an image forming apparatus and a method firmware history information offering method thereof, and more particularly, to an image forming apparatus capable of offering firmware history information to a user and a firmware history information offering method thereof.

2. Description of the Related Art

An image forming apparatus, such as a copying machine, a printer, or a facsimile machine, employs firmware to control hardware components. The firmware is stored in the image forming apparatus. The firmware should be continuously upgraded as needed to enhance performance of the image forming apparatus.

To upgrade the firmware, the image forming apparatus downloads the latest version of a firmware upgrade file by accessing a firmware offering server through a network or by using a host computer (such as a personal computer) or a portable storage medium that stores the firmware upgrade file.

Occasionally, a user has to check information about an upgrade history of the firmware. The user uses the host computer to separately download a text of upgrade history information, and checks the upgrade history information through the host computer. Thus, a user needs the host computer in order to check the upgrade history of the firmware. Further, it is inconvenient for a user to have to install an additional program for only the upgrade history information in the host computer as necessary. In order to print the upgrade history information, a user must generally connect a printer to the corresponding host computer and install a printer driver corresponding to the printer in the host computer.

### SUMMARY OF THE INVENTION

Aspects of the present invention provide an image forming apparatus capable of offering an upgrade history of firmware to a user without using a host computer when the firmware is upgraded, and a firmware history information offering method thereof.

Additional aspects of the present invention provide an image forming apparatus and a firmware history information offering method thereof, in which a user can easily check and print an upgrade history of firmware without installing a program, a driver, etc., separately.

According to an aspect of the present invention can a method of offering upgrade history information about firmware of an image forming apparatus is provided. The method comprises: receiving and storing a firmware upgrade history document and a firmware upgrade file; upgrading the firmware by executing the stored firmware upgrade file; and offering the stored firmware upgrade history document.

According to another aspect of the present invention, the firmware upgrade history document and the firmware upgrade file is received as a package file or separate files.

According to another aspect of the present invention, the firmware upgrade history document is distinguishable from the firmware upgrade file.

According to another aspect of the present invention, the firmware upgrade history document includes a text file, an image file and/or a predetermined print language file.

According to another aspect of the present invention, the offering of the firmware upgrade history document includes printing the firmware upgrade history document, displaying the firmware upgrade history document, and sending the firmware upgrade history document to an external device.

According to another aspect of the present invention, the method further includes receiving a user input, and the offering of the firmware upgrade history document includes offering the firmware upgrade history document according to the user input.

According to another aspect of the present invention, the firmware upgrade history document is offered while upgrading the firmware.

According to another aspect of the present invention, the receiving and the storing of the firmware upgrade history document includes updating a previously-stored firmware upgrade history document with the received firmware upgrade history document.

According to another aspect of the present invention, the offering of the firmware upgrade history document includes offering information about the updated firmware upgrade history document.

According to another aspect of the present invention, an image forming apparatus is provided. The image forming apparatus comprises: a communicating unit to receive a firmware upgrade history document and a firmware upgrade file; a storage unit to store the firmware upgrade history document and the firmware upgrade file; an output unit to offer the firmware upgrade history document; and a controller to upgrade firmware by executing the stored firmware upgrade file and to control the output unit to offer the firmware upgrade history document.

According to another aspect of the present invention, the output unit includes: a printing unit to print the firmware upgrade history document; a display unit to display the firmware upgrade history document; wherein the communication unit is included in the output unit, and sends the stored firmware upgrade history document to an external device.

According to another aspect of the present invention, the image forming apparatus further includes a user input unit to receive a user input, wherein the controller offers the firmware upgrade history document according to the user input.

According to another aspect of the present invention, the controller offers the firmware upgrade history document while upgrading the firmware.

According to another aspect of the present invention, the controller updates the previously-stored firmware upgrade history document with the received firmware upgrade history document.

According to another aspect of the present invention, the controller offers information about the updated firmware upgrade history document.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a block diagram of an image forming apparatus according to an embodiment of the present invention;

FIG. 2 illustrates an example of a user interface about an upgrade history of firmware;

FIG. 3 illustrates an example of a history document of a firmware stored in a printing job list; and

FIG. 4 is a flowchart of offering firmware history information in the image forming apparatus.

### DETAILED DESCRIPTION OF EMBODIMENTS OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

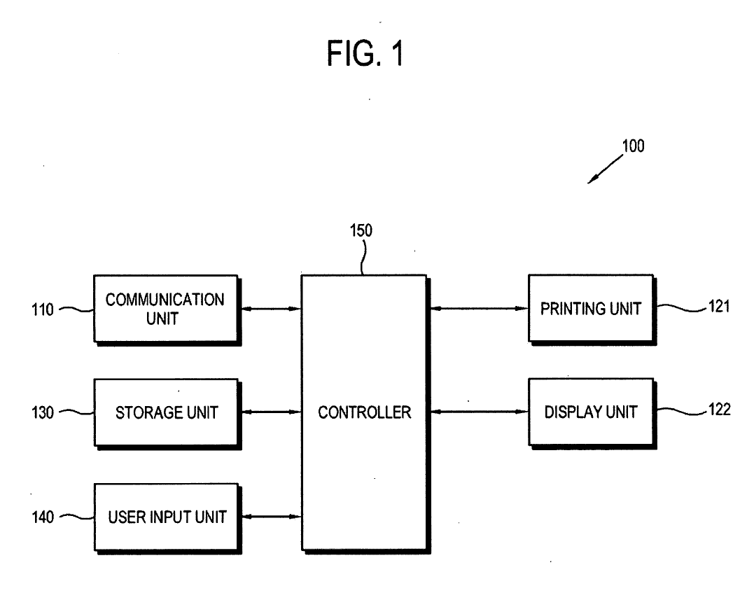

FIG. 1 is a block diagram of an image forming apparatus 100 according to an embodiment of the present invention. The image forming apparatus 100 forms and prints an image based on printing data transmitted from an external source, such as a storage device, an image processing apparatus such as a host computer, and the like. The image forming apparatus 100 may be as a printer, a copying machine, a facsimile machine, multifunction device, or the like.

The image forming apparatus 100 stores firmware to control hardware components of the image forming apparatus 100. The firmware should be continuously upgraded as needed to enhance performance of the image forming apparatus 100.

As shown in FIG. 1, the image forming apparatus 100 includes a communication unit 110, a printing unit 121, a display unit 122, a storage unit 130, a user input unit 140 and a controller 150. According to other aspects of the present invention, the image forming apparatus may include additional and/or different units. Similarly, the functionality of two or more of the above units may be integrated into a single component. The communication unit 110 receives the printing data, a firmware upgrade history document, a firmware upgrade file, and the like from an external source (such as the external storage device, the image processing apparatus, a firmware offering server, and the like) under control of the controller 150.

The firmware upgrade history document contains information about an upgrade history of the firmware, and may be a text file, an image file, and/or a predetermined print language file. For example, the firmware upgrade history document may be an image file having JPG, BMP or other format, or may be a printer language file such as a page description language (PDL), a printer command language (PCL), a printer job language (PJL), or the like.

The communication unit 110 may receive both the firmware upgrade history document and the firmware upgrade file at the same time. The communication unit 110 may receive a predetermined package file (hereinafter, referred to as a “firmware image file”) which includes the firmware upgrade history document and the firmware upgrade file. The firmware upgrade history document and the firmware upgrade file included in the received firmware image file may have identifiers expressed by symbols or letters distinguishable from each other.

The communication unit 110 may alternatively receive the firmware upgrade history document and the firmware upgrade file individually. For example, the image forming apparatus 100 may receive the firmware upgrade history document in response to a request of the user after receiving the firmware upgrade file and upgrading the firmware. The communication unit 110 may include a network card, a universal serial bus (USB) connector, and the like, according to types of communication with the external source.

The printing unit 121 and the display unit 122 provide the received firmware upgrade history document to the user. The printing unit 121 forms an image corresponding to the firmware upgrade history document received under the control of the controller 150 and prints the image. The printing unit 121 may use an inkjet method, a laser method, or other printing method.

The display unit 122 displays the firmware upgrade history document under the control of the controller 150. The display unit 122 may provide the user with a user interface (UI) about the upgrade history of the firmware.

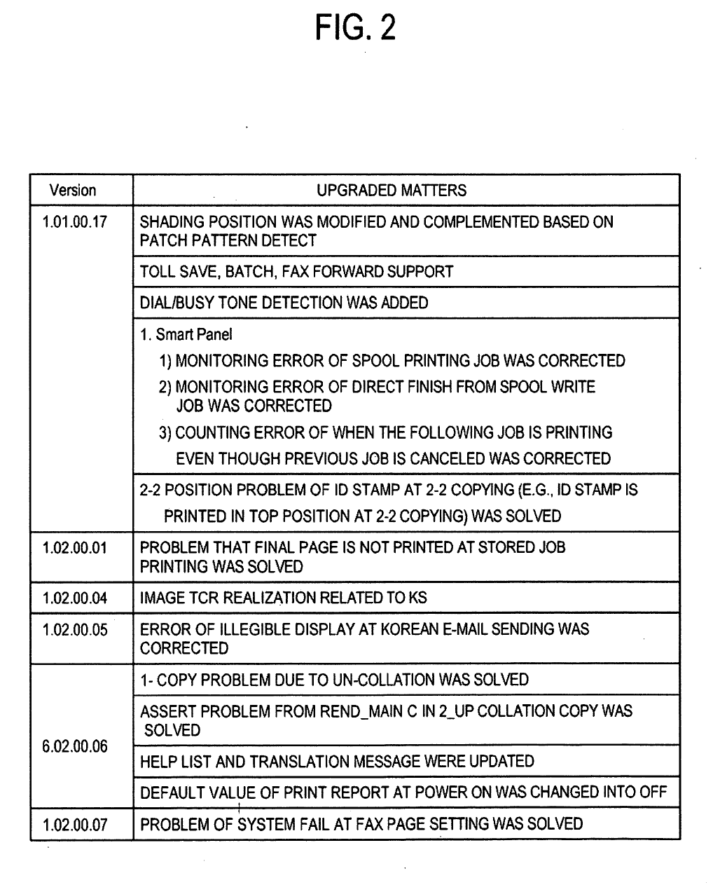

FIG. 2 shows an example of the UI about the upgrade history of firmware. The UI about the upgrade history of the firmware may include version information of the upgraded firmware and upgraded matters corresponding to the version information. The display unit 122 may include, for example, a thin film transistor-liquid crystal display (TFT-LCD) and a driver (not shown) to drive the TFT-LCD.

The image forming apparatus 100 may use the communication unit 110 to provide a user the firmware upgrade history document. The image forming apparatus 100 sends the received firmware upgrade history document to an external device via a network or the like under the control of the controller 150.

The firmware upgrade history document may be sent to a manager as an E-mail attachment. If the image forming apparatus 100 has an alert notify E-mail sending function that automatically sends an E-mail to the manager when an error occurs, the upgrade history of the firmware may be automatically sent to the manager through an E-mail when the firmware is upgraded via the alert notification function.

The printing unit 121, the display unit 122, and the communication unit 110 may be used to provide the firmware upgrade history document to a user, but an image forming apparatus according to aspects of the present invention need not include all three. The image forming apparatus 100 may be provided with any combination of one or two of the printing unit 121, the display unit 122, and the communication unit 110. The printing unit 121, the display unit 122, and the communication unit 110 of the image forming apparatus 100 according to aspects of the present invention may serve as an output unit to provide a user the firmware upgrade history document.

The storage unit 130 stores the firmware upgrade history document received under the control of the controller 150. For example, the storage unit 130 stores the firmware upgrade history document in a printing job list.

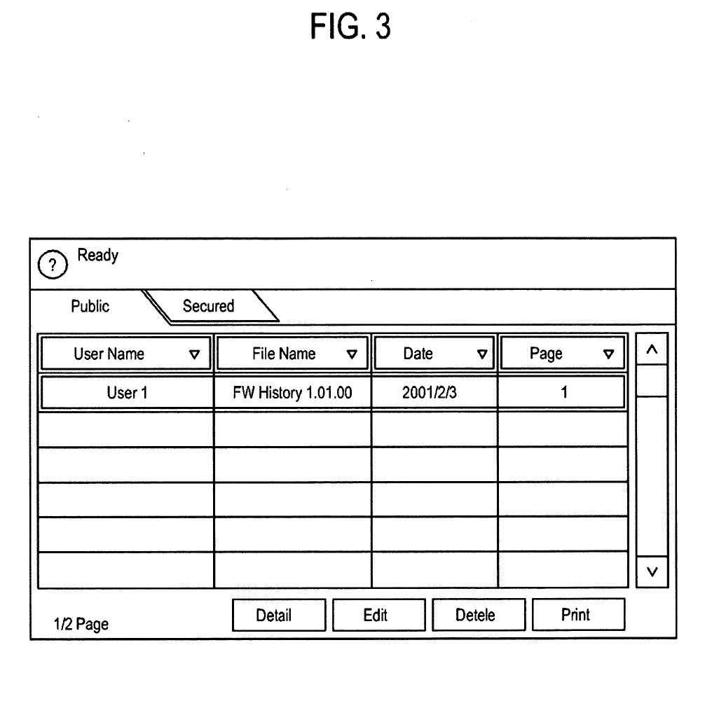

FIG. 3 shows an example of the firmware upgrade history document stored in the printing job list. The firmware upgrade history document may be stored in the form of a printing job in the printing job list. The stored printing job contains a user name, a file name, a changed date, a page number, etc. Such a stored printing job may be printed by the printing unit 121 as soon as the firmware upgrade history document is stored under the control of the controller 150, or sent in the form of an attached file of an E-mail to the network via the communication unit 110.

The controller 150 updates a firmware upgrade history document previously stored in the storage unit 130 with the received firmware upgrade history document. Further, the controller 150 provides updated history information of the firmware to a user. The storage unit 130 may be, for example, a flash memory, an erasable programmable read only memory (EPROM), a hard disk drive (HDD), etc.

The user input unit 140 receives instruction inputs from a user so as to operate the image forming apparatus 100, upgrade the firmware, receive the firmware upgrade history document, and provide a user the received firmware upgrade history document. The user input unit 140 may be realized as a function key corresponding to functions of the image forming apparatus 100, a numeral key, a keyboard, a touchscreen, a mouse, or other device to receive input from a user. The user input unit 140 may further include separate function keys to receive a user's instruction to upgrade the firmware and receive and offer the firmware upgrade history document.

According to a user's instruction input to the user input unit 140, the image forming apparatus 100 is capable of printing, displaying, or sending the firmware upgrade history document stored in the storage unit 130. The image forming apparatus 100 may delete the firmware upgrade history document upon expiration.

The controller 150 generally controls the image forming apparatus 100. The controller 150 may be achieved by, for example, a central processing unit (CPU). The controller 150 receives the firmware upgrade history document and the firmware upgrade file via through the communication unit 110, and provides the received firmware upgrade history document to a user. The controller 150 may provide the user with the firmware upgrade history document as soon as the controller 150 receives the firmware upgrade history document or after storing the firmware upgrade history document in the printing job list of the storage unit 130.

The controller 150 may control the firmware upgrade history document to be converted and stored so that the firmware upgrade history document can have a format proper to be offered to a user. For example, if the firmware upgrade history document is an image file having a BMP or JPG format, the controller 150 may convert the firmware upgrade history document into a printer language file proper to be printed through the printing unit 121, and stores the converted firmware upgrade history document in the storage unit 130.

The controller 150 may convert the firmware upgrade history document stored in the storage unit 130 and offer the firmware upgrade history document to the user. For example, the controller 150 may convert the firmware upgrade history document stored as the print language file in the storage unit 130 into the image file to be displayed through the display unit 122, or into the attached file of the E-mail to be sent through the communication unit 110.

The controller 150 executes the received firmware upgrade file and upgrades the firmware. When the firmware is completely upgraded, the controller 150 may reboot the image forming apparatus 100. Since the firmware upgrade history document is stored in the storage unit 130, the firmware upgrade history document can be offered to a user as necessary even after rebooting the image forming apparatus 100. Further, the controller 150 may cancel the process of rebooting the image forming apparatus 100.

The controller 150 may control the communication unit 110 to receive both the firmware upgrade history document and the firmware upgrade file at the same time, or to receive the firmware upgrade history document corresponding to a user's instruction through the user input unit 140 independently of receiving and executing the firmware upgrade file. Further, the controller 150 may offer the firmware upgrade history document from the storage unit 130 to the user according to the user's instruction through the user input unit 140 independently of receiving and executing the firmware upgrade file.

Thus, the image forming apparatus 100 may offer the firmware upgrade history document to the user without using a host computer, so that the user can check the corresponding firmware upgrade history document through the output part of the image forming apparatus 100 without installing an exclusive program, driver, or the like separately.

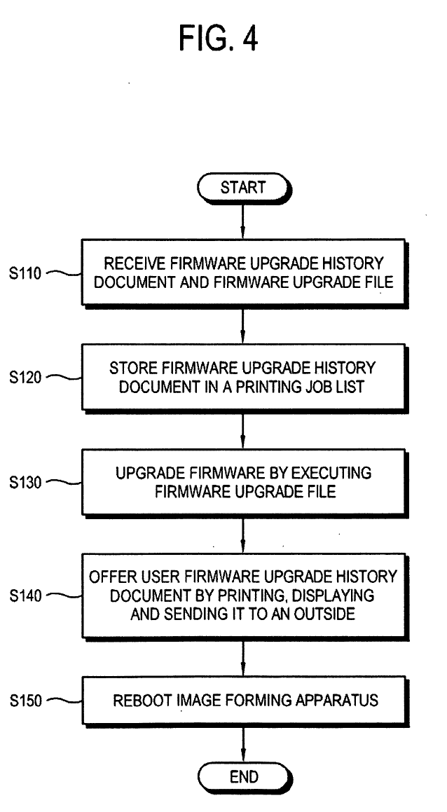

A process of offering the firmware upgrade history information will be described below with reference to FIG. 4. At operation S110, the image forming apparatus 100 receives the firmware upgrade history document and the firmware upgrade file. The firmware upgrade history document may have an identifier distinguishable from the firmware upgrade file, and may be one of text, image, and predetermined print language files, as discussed above.

In operation S110, the controller 150 receives the firmware upgrade history document and the firmware upgrade file according to a user's instruction through the user input unit 140. The controller 150 may receive both the firmware upgrade history document and the firmware upgrade file at the same time or separately.

In operation S120, the controller 150 stores the received firmware upgrade history document in the printing job list of the storage unit 130. The controller 150 may convert the firmware upgrade history document to have a format proper to be offered to a user, and then store the firmware upgrade history document in the storage unit 130. In operation S130, the controller 150 executes the firmware upgrade file and upgrades the firmware.

In operation S140, the controller 150 offers a user the firmware upgrade history document received in operation S110. The controller 150 may offer the user the received firmware upgrade history document without storing the received firmware upgrade history document in the storage unit 130, or may offer the stored firmware upgrade history document from the storage unit 130. Thus, operation S140 may include a process of converting the firmware upgrade history document stored in the storage unit 130 to have a format proper to be offered to a user. The image forming apparatus 100 may also offer a user the firmware upgrade history document while upgrading the firmware by, for example. The image forming apparatus 100 may offer a user the firmware upgrade history document by printing, displaying, and/or sending the firmware upgrade history document to the outside.

Operation S140 may be performed automatically when upgrading the firmware, or performed according to a user's instruction independent of upgrading the firmware. Further, the printing, the displaying and the sending of the firmware upgrade history document may be performed in sequence, or performed independently of one another. The printing, the displaying, or the sending of the firmware upgrade history document may be performed as necessary.

After completing operation S140, the controller 150 reboots the image forming apparatus 100 in operation S150. Operation S150 may immediately follow the operation S130. Since the firmware upgrade history document is maintained as it is stored in the storage unit 130 at the operation S120, the stored firmware upgrade history document can be offered anytime according to a user's request. The rebooting process in operation S150 may be canceled as necessary.

In the foregoing embodiment, the firmware upgrade file is executed at the operation S130 and the firmware upgrade history document is offered to a user at the operation S140, but aspects of the present invention are not limited thereto. According to another aspect of the present invention, the firmware upgrade history document may be offered before the firmware upgrade file is executed.

As described above, an image forming apparatus and a firmware history information offering method thereof according to aspects of the present invention can easily offer a changed history of firmware to a user without using a host computer when the firmware is upgraded. Further, a user can easily check and print a changed history of firmware without installing a program, a driver, or the like separately.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CDs, DVDs, Blu-ray discs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few exemplary embodiments of the present invention have been shown and described, it would be appreciated by those skilled in the art that changes may be made in these embodiments without departing from the principles and spirit of the invention, the scope of which is defined in the appended claims and their equivalents.

What is claimed is:

1. A method of offering upgrade history information about firmware of an image forming apparatus, the method comprising:
receiving and storing a firmware upgrade history document and a firmware upgrade file;
upgrading the firmware by executing the stored firmware upgrade file; and
offering the stored firmware upgrade history document.

2. The method according to claim 1, wherein the firmware upgrade history document and the firmware upgrade file are received as a package file or separate files.

3. The method according to claim 2, wherein the firmware upgrade history document is distinguishable from the firmware upgrade file.

4. The method according to claim 2, wherein the firmware upgrade history document comprises a text file, an image file, and/or a predetermined print language file.

5. The method according to claim 1, wherein the offering of the firmware upgrade history document comprises at least one of printing the firmware upgrade history document, displaying the firmware upgrade history document, and sending the firmware upgrade history document to an external device.

6. The method according to claim 1, further comprising:
receiving a user input;
wherein the offering of the firmware upgrade history document comprises offering the firmware upgrade history document according to the user input.

7. The method according to claim 1, wherein the firmware upgrade history document is offered while upgrading the firmware.

8. The method according to claim 1, wherein the receiving and the storing of the firmware upgrade history document comprise updating a previously-stored firmware upgrade history document with the received firmware upgrade history document.

9. The method according to claim 8, wherein the offering of the firmware upgrade history document comprises offering information about the updated firmware upgrade history document.

10. An image forming apparatus comprising:
a communicating unit to receive a firmware upgrade history document and a firmware upgrade file;
a storage unit to store the firmware upgrade history document and the firmware upgrade file;
an output unit to offer the firmware upgrade history document; and
a controller to upgrade firmware by executing the stored firmware upgrade file and to control the output unit to offer the firmware upgrade history document.

11. The image forming apparatus according to claim 10, wherein the firmware upgrade history document and the firmware upgrade file are received as a package file or separate files.

12. The image forming apparatus according to claim 11, wherein the firmware upgrade history document is distinguishable from the firmware upgrade file.

13. The image forming apparatus according to claim 11, wherein the firmware upgrade history document comprises a text file, an image file, and/or a predetermined print language file.

14. The image forming apparatus according to claim 10, wherein the output unit comprises:
a printing unit to print the firmware upgrade history document; and
a display unit to display the firmware upgrade history document; and
wherein the communication unit is included in the output unit, and sends the stored firmware upgrade history document to an external device.

15. The image forming apparatus according to claim 10, further comprising:
a user input unit to receive user input;
wherein the controller offers the firmware upgrade history document according to the user input.

16. The image forming apparatus according to claim 10, wherein the controller offers the firmware upgrade history document while upgrading the firmware.

17. The image forming apparatus according to claim 10, wherein the controller updates the previously-stored firmware upgrade history document with the received firmware upgrade history document.

18. The image forming apparatus according to claim 17, wherein the controller offers information about the updated firmware upgrade history document.

19. A computer readable medium comprising instructions that, when executed by an image forming apparatus, cause the image forming apparatus to perform the method of claim 1.

20. A method of offering firmware upgrade history information about firmware of an image forming apparatus, the method comprising:
receiving the firmware upgrade history information;
storing the firmware upgrade history information in a predetermined location; and
offering the firmware upgrade history information to a user.

21. The method of claim 20, further comprising:
receiving a firmware upgrade; and
installing the firmware upgrade in the image forming apparatus.
